(19) United States
(12) Patent Application Publication
(10) Pub. No.: US 2010/0118230 A1
(43) Pub. Date: May 13, 2010

(54) BACKLIGHT DEVICE AND LIQUID CRYSTAL DISPLAY DEVICE

(76) Inventor: Masayuki Murao, Osaka (JP)

Correspondence Address: HARNESS, DICKEY & PIERCE, P.L.C., P.O. BOX 8910, RESTON, VA, 20195, US

(21) Appl. No.: 12/450,513

(22) PCT Filed: Mar. 25, 2008
(86) PCT No.: PCT/JP2008/055546

§ 371 Date: Sep. 29, 2009

(30) Foreign Application Priority Data
Apr. 18, 2007 (JP) 2007-109667

(51) Int. Cl. G02F 1/1335; H05B 41/26

(52) U.S. Cl. 349/65; 315/287; 362/97.1

(57) ABSTRACT

In one embodiment of the present invention, a backlight device is disclosed wherein a contrast ratio is improved with a decrease in light source service life being suppressed, and a liquid crystal display device using such backlight device. The backlight device is provided with an, optical layer whose main surface is a light outgoing surface; a main light source that is arranged at a position facing a main surface of the optical layer and emits light toward the optical layer; a light guide plate that is arranged on a main surface side, so as to be parallel to the main surface, and has a main surface on an optical layer side as a light outgoing surface; a sub-light source that is arranged at a position facing a side surface of the light guide plate and emits light toward the side surface; and a driving portion for driving the main light source and the sub-light source. The main light source is provided with a plurality of fluorescent tubes arranged parallel to the optical layer. The driving portion outputs drive pulses to the plurality of the fluorescent tubes, respectively, and adjusts the light amounts of the plurality of the fluorescent tubes by modulating the pulse widths of the drive pulses (PWM dimming method).

### TECHNICAL FIELD

The present invention relates to a backlight device, and to a liquid crystal display device provided with the backlight device.

### BACKGROUND ART

In general, a liquid crystal display device, except for a reflection type that forms images by reflecting external light, is provided with a backlight device. Some of such backlight devices utilize fluorescent tubes or light-emitting diodes as light sources. The fluorescent tube is mostly used as a light source for the backlight device, with a light amount and a service life being taken into consideration.

Further, in the liquid crystal display device, dimming of the backlight device is performed automatically or manually in accordance with the ambient light intensity, the contrast of a display image, and the like. As the dimming method adopted when a fluorescent tube is used as a light source of the backlight device, the current dimming method and the PWM (Pulse Width Modulation) dimming method are known.

The current dimming method, in which the dimming is performed by increasing or decreasing current passing through the fluorescent tube, has a difficulty in widening a dimming range. Therefore, the PWM dimming method is adopted in many backlight devices. In the PWM dimming method, the dimming is performed in such a manner that the output of an inverter circuit is switched on/off forcibly, and a ratio between the on-time and the off-time (duty ratio) is modulated. The PWM dimming method allows a wider dimming range to be achieved compared to the current dimming method.

However, even if the PWM dimming method is adopted, there is a limit on the widening of the dimming range. On the other hand, in recent years, a wider dimming range has been demanded for improving the image quality of display images. In view of this, the dimming performed by the PWM dimming method and the current dimming method in combination has been proposed (for example, refer to JP 2003-359097 A).

In a backlight device disclosed by JP 2003-359097 A, when an especially high contrast ratio is required, a pulse signal for performing the PWM dimming and a voltage signal for performing the current dimming are multiplied together, and the signal obtained by the multiplication (drive pulse) is fed to the inverter circuit. In this case, since the level of the drive pulse becomes higher than that in the case in which only the PWM dimming is performed, the value of the current passing through the fluorescent tube is increased, whereby brightness of a display screen is increased. Therefore, a wider dimming range (an improved contrast ratio) can be obtained compared to the backlight device in which the dimming is performed by the PWM dimming method alone.

### DISCLOSURE OF INVENTION

### Problem to be Solved by the Invention

However, in the backlight device disclosed by JP 2003-359097 A, although the increased current passing through the fluorescent tube allows the dimming range (contrast ratio) to be wider compared to the backlight device in which only the PWM dimming is adopted, it causes the service life of the fluorescent tube to decrease.

Therefore, it is an object of the present invention to solve the above-described problem, and to provide a backlight device capable of improving a contrast ratio while suppressing a decrease in a service life of a light source, and a liquid crystal display device using the backlight device.

### Means for Solving Problem

In order to achieve the aforementioned object, a backlight device according to the present invention includes: an optical layer having one of main surfaces thereof as a light outgoing surface; a main light source that is disposed at a position facing the other main surface of the optical layer and emits light toward the optical layer; a light guide plate that is disposed on a side of the other main surface of the optical layer, so as to be parallel to the optical layer, and has a main surface on an optical layer side as a light outgoing surface; a sub-light source that is disposed at a position facing a side surface of the light guide plate and emits light toward the side surface; and a driving portion for driving the main light source and the sub-light source, wherein the main light source includes a plurality of fluorescent tubes disposed parallel to the optical layer, and the driving portion outputs drive pulses with respect to the plurality of the fluorescent tubes, respectively, and adjusts light amounts of the plurality of the fluorescent tubes by modulating pulse widths of the drive pulses.

In order to achieve the aforementioned object, a liquid crystal display device according to the present invention includes: a liquid crystal display panel; and a backlight device for illuminating the liquid crystal display panel from a back surface thereof, wherein the backlight device includes: an optical layer having one of main surfaces thereof as a light outgoing surface; a main light source that is disposed at a position facing the other main surface of the optical layer and emits light toward the optical layer; a light guide plate that is disposed on a side of the other main surface of the optical layer, so as to be parallel to the optical layer, and has a main surface on an optical layer side as a light outgoing surface; a sub-light source that is disposed at a position facing a side surface of the light guide plate and emits light toward the side surface; and a driving portion for driving the main light source and the sub-light source, wherein the main light source includes a plurality of fluorescent tubes disposed parallel to the optical layer, and the driving portion outputs drive pulses with respect to the plurality of the fluorescent tubes, respectively, and adjusts light amounts of the plurality of the fluorescent tubes by modulating pulse widths of the drive pulses.

### EFFECTS OF THE INVENTION

In the present invention, a backlight device is provided with a sub-light source in addition to a main light source, and therefore, can obtain an amount of light that can hardly be obtained by the conventional backlight device that is provided with only a main light source. Besides, in the present invention, this makes it unnecessary to perform current dimming with respect to a fluorescent tube in addition to PWM dimming as in the conventional case, thereby suppressing an increment in a value of current passing through the fluorescent tube (main light source). Therefore, the backlight device according to the present invention is capable of improving a contrast ratio while suppressing a decrease in a service life of a light source.

### BRIEF DESCRIPTION OF DRAWINGS

FIG. 1 is a perspective view three-dimensionally showing a schematic configuration of an optical portion of a backlight device according to Embodiment 1 of the present invention.

FIG. 2 is a side view of the optical portion of the backlight device shown in FIG. 1.

FIG. 3 is a block diagram showing configurations of the backlight device and a liquid crystal display device according to Embodiment 1 of the present invention.

FIG. 4 is a block diagram showing a specific configuration of a driving portion constituting the backlight device shown in FIG. 3.

FIGS. 5(a) to 5(d) are diagrams showing exemplary drive pulses for a main light source that have different duty ratios, respectively.

FIGS. 6(a) to 6(d) are diagrams showing exemplary drive pulses for a sub-light source that have different duty ratios, respectively.

FIG. 7 is a block diagram showing configurations of a backlight device and a liquid crystal display device according to Embodiment 2 of the present invention.

FIG. 8 is a block diagram showing a specific configuration of a driving portion constituting the backlight device shown in FIG. 7.

FIG. 9 is a circuit diagram exclusively showing a portion for driving the sub-light source in the driving portion shown in FIG. 7.

### DESCRIPTION OF PREFERRED EMBODIMENTS

A backlight device according to the present invention includes: an optical layer having one of main surfaces thereof as a light outgoing surface; a main light source that is disposed at a position facing the other main surface of the optical layer and emits light toward the optical layer; a light guide plate that is disposed on a side of the other main surface of the optical layer, so as to be parallel to the optical layer, and has a main surface on an optical layer side as a light outgoing surface; a sub-light source that is disposed at a position facing a side surface of the light guide plate and emits light toward the side surface; and a driving portion for driving the main light source and the sub-light source, wherein the main light source includes a plurality of fluorescent tubes disposed parallel to the optical layer, and the driving portion outputs drive pulses with respect to the plurality of the fluorescent tubes, respectively, and adjusts light amounts of the plurality of the fluorescent tubes by modulating pulse widths of the drive pulses.

Further, a liquid crystal display device according to the present invention includes: a liquid crystal display panel; and a backlight device for illuminating the liquid crystal display panel from a back surface thereof, wherein the backlight device includes: an optical layer having one of main surfaces thereof as a light outgoing surface; a main light source that is disposed at a position facing the other main surface of the optical layer and emits light toward the optical layer; a light guide plate that is disposed on a side of the other main surface of the optical layer, so as to be parallel to the optical layer, and has a main surface on an optical layer side as a light outgoing surface; a sub-light source that is disposed at a position facing a side surface of the light guide plate and emits light toward the side surface; and a driving portion for driving the main light source and the sub-light source, wherein the main light source includes a plurality of fluorescent tubes disposed parallel to the optical layer, and the driving portion outputs drive pulses with respect to the plurality of the fluorescent tubes, respectively, and adjusts light amounts of the plurality of the fluorescent tubes by modulating pulse widths of the drive pulses.

The backlight device and the liquid crystal display device according to the aforementioned present invention may be configured so that the sub-light source is a fluorescent tube disposed along the side surface of the light guide plate, and the driving portion further outputs a drive pulse with respect to the fluorescent tube constituting the sub-light source and adjusts a light amount of the fluorescent tube constituting the sub-light source by modulating a pulse width of the drive pulse.

Further, the backlight device and the liquid crystal display device according to the present invention described above may be configured so that the sub-light source is a light-emitting diode disposed along the side surface of the light guide plate, and the driving portion adjusts a light amount of the light-emitting diode constituting the sub-light source by modulating a value of current supplied to the light-emitting diode constituting the sub-light source.

In the backlight device and the liquid crystal display device according to the present invention described above, the main light source preferably is disposed between the optical layer and the light guide plate. In this case, a decline in output efficiency of the main light source can be suppressed.

The liquid crystal display device according to the present invention described above preferably further includes a control portion that causes the driving portion to adjust the light amounts of the main light source and the sub-light source in accordance with a configuration of an image displayed on a display screen of the liquid crystal display panel. In this case, the image quality of the display image can be improved.

### Embodiment 1

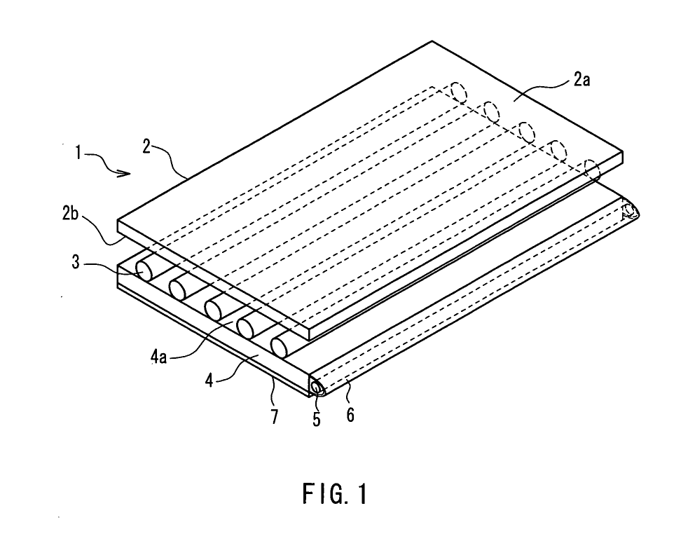

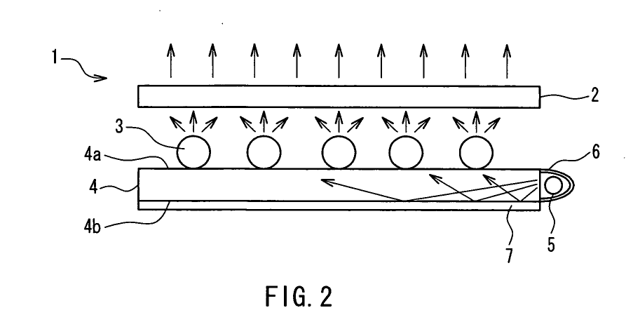

Hereinafter, a backlight device and a liquid crystal display device in Embodiment 1 of the present invention will be described with reference to FIGS. 1 to 6. First, a schematic configuration of an optical portion of the backlight device in the present Embodiment 1 will be described with reference to FIGS. 1 and 2. FIG. 1 is a perspective view three-dimensionally showing a schematic configuration of an optical portion of a backlight device according to Embodiment 1 of the present invention. FIG. 2 is a side view of the optical portion of the backlight device shown in FIG. 1.

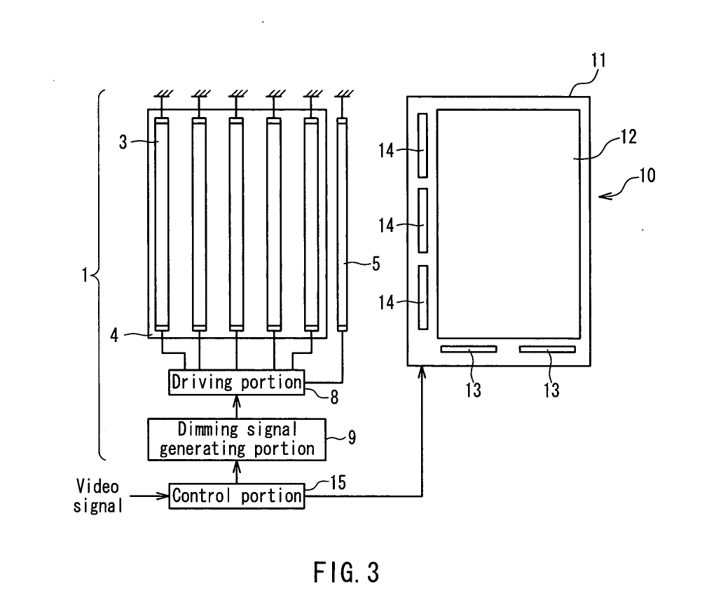

As shown in FIGS. 1 and 2, a backlight device 1 in the present Embodiment 1 includes the following as an optical portion: an optical layer 2, a main light source 3, a light guide plate 4, and a sub-light source 5. Although it is not shown in FIG. 1 or 2, the backlight device 1 further includes a driving portion (see FIG. 3) for driving the main light source 3 and the sub-light source 5.

The optical layer 2 uniforms brightness by diffusing light from the main light source 3 and light from the sub-light source 5 emitted via the light guide plate 4. One main surface 2a of the optical layer 2 serves as a light outgoing surface of the backlight device 1. The optical layer 2 is formed by, for example, laminating a diffusion sheet, a prism sheet, a reflection/polarization sheet and the like in order.

The main light source 3 is disposed at a position facing the other main surface 2b of the optical layer 2, and emits light toward the optical layer 2. In the present Embodiment 1, the main light source 3 is formed of a plurality of fluorescent tubes. The plurality of the fluorescent tubes constituting the main light source 3 are disposed in parallel between the optical layer 2 and the light guide plate 4. The main light source 3 functions in the same manner as that in the conventional direct-type backlight device.

The light guide plate 4 is disposed on the main surface 2b side of the optical layer 2, so as to be parallel to the main surface 2b. The sub-light source 5 is disposed at a position facing one side surface of the light guide plate 4, and emits light toward the side surface. In the present Embodiment 1, a fluorescent tube is used as the sub-light source 5. The light guide plate is formed of a transparent acrylic plate or the like, and a reflection sheet 7 is provided on a bottom surface 4b of the light guide plate 4. Although it is not shown, a reflection sheet also is provided on a side surface of the light guide plate 4 opposite to the side facing the sub-light source 5.

Further, a lamp reflector 6 is attached so as to surround the fluorescent tube, which serves as the sub-light source 5. Thus, the light that has been emitted by the sub-light source 5 and enters the light guide plate 4 through the side surface thereof is reflected repeatedly inside the light guide plate 4 and goes out through a main surface (top surface) 4a of the light guide plate 4 on the optical layer 2 side to the outside. The main surface 4a serves as a light outgoing surface. The light guide plate 4 and the sub-light source 5 function in the same manner as those in the conventional sidelight-type backlight device.

It should be noted that, in the example shown in FIGS. 1 and 2, the fluorescent tube constituting the sub-light source 5 is a straight tube, but Embodiment 1 is not limited to this configuration. The fluorescent tube constituting the sub-light source 5 may be a U-shaped tube, a L-shaped tube, a pseudo U-shaped tube that is obtained by connecting end parts of two straight tubes with a bridge, an angular U-shaped tube (channel-shaped tube) that is obtained by folding two portions of a tube vertically in the same direction, or the like. Further, the number of fluorescent tubes constituting the sub-light source 5 is not limited; it may be two or more. For example, the example shown in FIGS. 1 and 2 may have a configuration in which each of the opposing side surfaces is provided with one fluorescent tube.

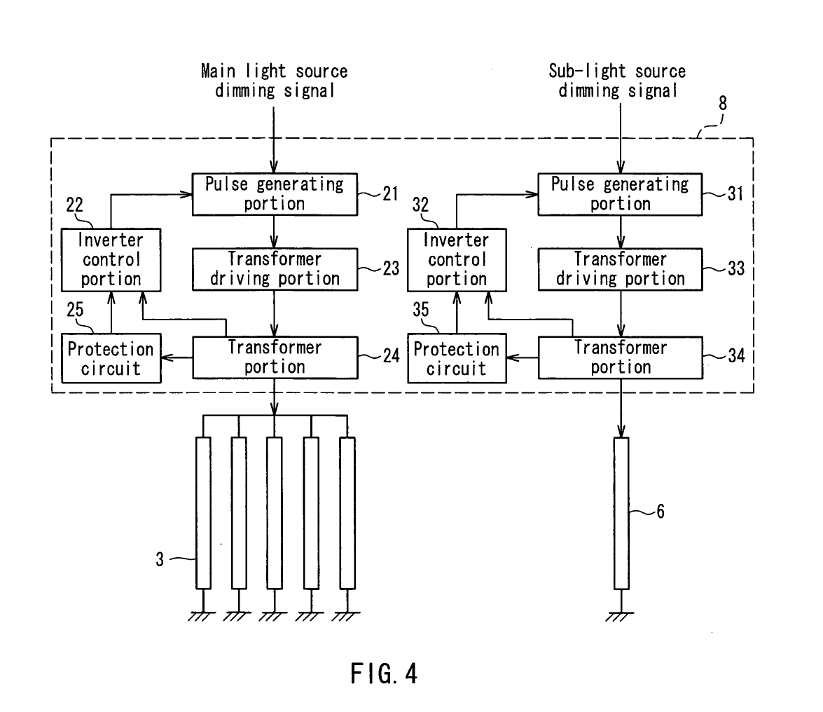

Next, a configuration of an entirety of the backlight device (also including portions other than the optical portion) in the present Embodiment 1 and the liquid crystal display device utilizing the backlight device in the present Embodiment 1 will be described with reference to FIGS. 3 and 4. FIG. 3 is a block diagram showing configurations of the backlight device and a liquid crystal display device according to Embodiment 1 of the present invention.

As shown in FIG. 3, the liquid crystal display device in the present Embodiment 1 includes the backlight device 1, a liquid crystal display panel 10, and a control portion 15. The liquid crystal display panel 10 is provided with an active matrix substrate 11 on which pixels are formed in matrix, a filter substrate 12 on which color filters corresponding to each pixel are formed, and a liquid crystal layer (not shown) interposed therebetween. The pixels are mainly composed of TFTs and pixel electrodes. A gate driver IC 13 and a source driver IC 14 are mounted on the active matrix substrate 11 in a region where the filter substrate 12 is not placed (in a region surrounding a region where the pixels are formed).

External equipment (not shown) connected to the liquid crystal display device inputs a video signal to the control portion 15. Receiving the video signal, the control portion 15 inputs a control signal and the like corresponding to the video signal to the gate driver IC 13 and the source driver IC 14. Consequently, the gate driver IC 13 and the source driver IC 14 are activated, and the pixels are driven in accordance with the video signal. At this time, when illumination light is emitted from the backlight device 1, a video image is displayed on a display screen.

As shown in FIG. 3, the backlight device 1 in the present Embodiment 1 further includes a driving portion 8 and a dimming signal generating portion 9 in addition to the configuration shown in FIGS. 1 and 2. The dimming signal generating portion 9 generates a main light source dimming signal for setting the light amount of each fluorescent tube constituting the main light source 3, and a sub-light source dimming signal for setting the light amount of the fluorescent tube constituting the sub-light source 5, and inputs these signals to the driving portion 8 (see FIG. 4). In the present embodiment, each of the main light source dimming signal and the sub-light source dimming signal is a direct voltage signal for setting a light amount by specifying it with a voltage level or pulse signal for setting a light amount by specifying it with a duty ratio.

Further, the generation of the main light source dimming signal and the sub-light source dimming signal by the dimming signal generating portion 9 is performed in accordance with an instruction given by the control portion 15. In the present Embodiment 1, in order for a video image displayed according to the video signal to obtain an optimal brightness, the control portion 15 gives an instruction to the dimming signal generating portion 9 concerning the light amounts of the respective light sources. For example, when the control portion 15 requires the backlight device 1 to provide maximum brightness, the dimming signal generating portion 9 generates a main light source dimming signal for maximizing the light amount of the main light source, and a sub-light source dimming signal for maximizing the light amount of the sub-light source.

The driving portion 8 is an inverter. When the main light source dimming signal and the sub-light source dimming signal are input to the driving portion 8 from the dimming signal generating portion 9, the driving portion 8 drives the main light source 3 and the sub-light source 5 in accordance with these signals. Specifically, the driving portion 8 generates a drive pulse having a duty ratio corresponding to the voltage level or the duty ratio of the main light source dimming signal, and outputs this pulse to the plurality of the respective fluorescent tubes constituting the main light source 3. Further, the driving portion 8 also generates a drive pulse having a duty ratio corresponding to the voltage level or the duty ratio of the sub-light source dimming signal, and outputs this pulse to the fluorescent tube constituting the sub-light source 5.

In the present Embodiment 1, the driving portion 8 separately drives the plurality of the fluorescent tubes constituting the main light source 3 and the fluorescent tube constituting the sub-light source 5 in accordance with instructions given by the control portion 15, by a so-called PWM dimming method.

Here, a specific configuration of the driving portion 8 is described with reference to FIG. 4. FIG. 4 is a block diagram showing a specific configuration of a driving portion constituting the backlight device shown in FIG. 3. As shown in FIG. 4, the driving portion 8 includes pulse generating portions 21 and 31, inverter control portions 22 and 32, transformer driving portions 23 and 33, transformer portions 24 and 34, and protection circuits 25 and 35.

Among these, the pulse generating portion 21, the inverter control portion 22, the transformer driving portion 23, the transformer portion 24, and the protection circuit 25 are used for generating a drive pulse for the main light source. On the other hand, the pulse generating portion 31, the inverter control portion 32, the transformer driving portion 33, the transformer portion 34, and the protection circuit 35 are used for generating a drive pulse for the sub-light source.

The pulse generating portions 21 and 31, when the dimming signals input thereto are direct voltage signals, generate pulses having duty ratios corresponding to the voltage levels and input the same to the corresponding transformer driving portions 23 and 33, respectively. Specifically, each of the pulse generating portions 21 and 31 compares a dimming signal with a triangular wave signal as a reference, and generates a pulse as follows: when the level of the dimming signal is higher than that of the triangular wave signal, the pulse has a high level; and when the level of the dimming signal is lower than that of the triangular wave signal, the pulse has a low level. Further, in the case where the dimming signals input thereto are pulse signals, the pulse generating portions 21 and 31 adjust amplitudes thereof, and the like.

The inverter control portions 22 and 32 perform basic inverter control with respect to the pulse generating portions 21 and 31. The inverter control portions 22 and 32 further perform current control of the corresponding pulse generating portions 21 and 31, respectively, in accordance with feedback signals from current regulator circuits of the transformer driving portions 23 and 33, which will be described later. The inverter control portions 22 and 32 further perform safety control in accordance with error signals from the protection circuits 25 and 35, which will be described later.

Each of the transformer driving portions 23 and 33 is provided with a current amplifier circuit, a level shift circuit, and a transformer drive circuit, and using these, the transformer driving portions 23 and 33 drive the transformer portions 24 and 34. In order to enhance the driving ability of pulses generated by the pulse generating portions 21 and 31, the current amplifier circuits amplify the current values of the pulses. The level shift circuit has a circuit for generating a gate signal of a P-channel type transistor. The transformer drive circuit has an inverter circuit of a full-bridge or a half-bridge type, a push-pull type, or the like.

The transformer portion includes a transformer for converting a voltage of an input pulse into a higher voltage suitable for lighting fluorescent tubes; a current regulator circuit for adjusting a lamp current by feedback control; and an output abnormality detection circuit for detecting an abnormality of the output. The feedback signal from the current regulator circuit is input to the inverter control portions 22 and 32. The signal from the output abnormality detection circuit is input to the protection circuits 25 and 35. When the output abnormality is detected, the protection circuits 25 and 35 output error signals to the inverter control portions 22 and 32, respectively.

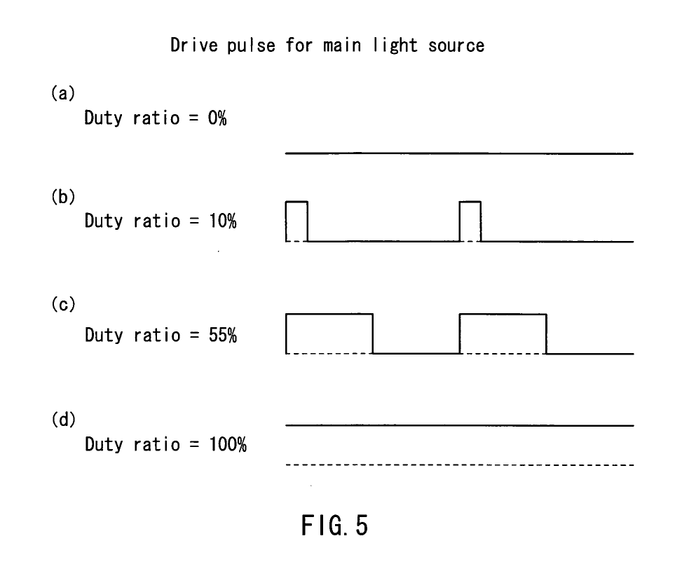

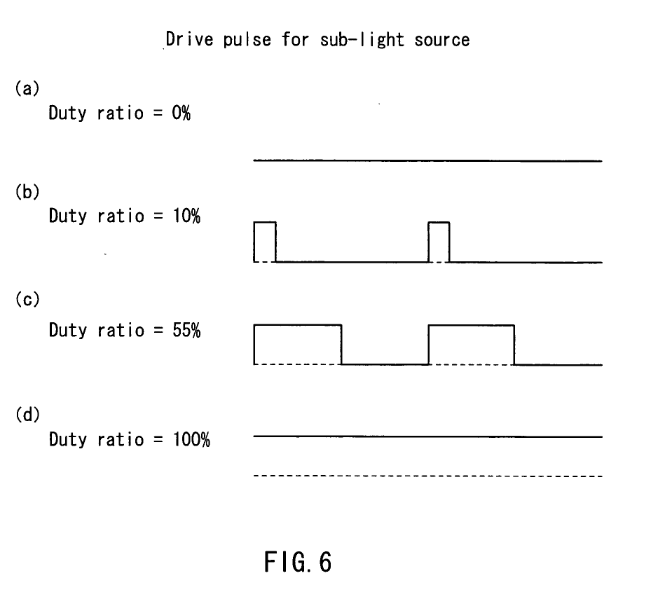

Next, a dimming range in the case where the backlight device in the present Embodiment 1 is used will be described with reference to FIGS. 5 and 6. FIGS. 5(a) to 5(d) are diagrams showing exemplary drive pulses for a main light source that have different duty ratios, respectively. FIGS. 6(a) to 6(d) are diagrams showing exemplary drive pulses for a sub-light source that have different duty ratios, respectively.

As shown in FIGS. 5(a) to 5(d) and FIGS. 6(a) to 6(d), in the present Embodiment 1, it is assumed that the driving portion 8 outputs, for example, four kinds of drive pulses having different duty ratios with respect to both the main light source 3 and the sub-light source 5. Here, when the brightness at the light outgoing surface of the backlight device 1, in the case that the duty ratio of the drive pulse for the sub-light source is 0% and the duty ratio of the drive pulse for the main light source is 100%, is assumed to be 100%, the dimming ranges will be described as shown in Table 1. It should be noted that Table 1 is merely an example showing the case where the light amount of the sub-light source 5 varies in the range of −20% to +20% to the light amount of the main light source.

TABLE 1

Duty ratio of the drive pulse
for the main light source [%]

| | | 0 | 10 | 55 | 100 |
|---|---|---|---|---|---|
| Duty ratio of | 0 | 0% | 5% | 50% | 100% |
| the drive pulse | 10 | 1% | 6% | 51% | 101% |
| for the sub- | 55 | 10% | 15% | 60% | 110% |
| light source [%] | 100 | 20% | 25% | 70% | 120% |

As shown in Table 1, the backlight device according to the present Embodiment 1 is capable of increasing the maximum brightness, and thus, widening a dimming range, compared to the conventional backlight device in which only a main light source is provided. Accordingly, the liquid crystal display device according to the present Embodiment 1 increases a contrast ratio of a display screen compared to the conventional type. Further, in the backlight device according to the present Embodiment 1, current dimming is not performed with respect to the main light source 3 and the sub-light source 5, whereby an increment in a value of current passing therethrough is suppressed. Therefore, a decrease in the service life of these light sources can be suppressed as well.

Further, as shown in Table 1, since the light amounts of the main light source and the sub-light source are adjusted separately, the brightness of the entire backlight device can be adjusted finely. This makes it possible to set the brightness optimal for a video image easily, thereby improving the image quality of display images.

### Embodiment 2

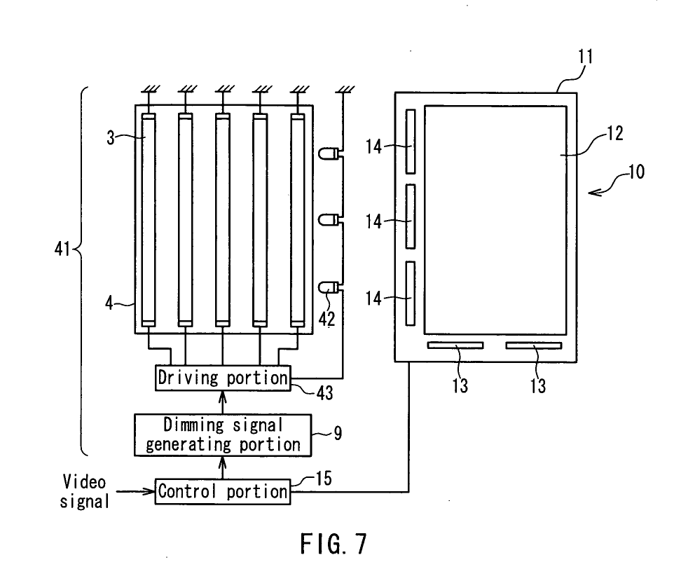

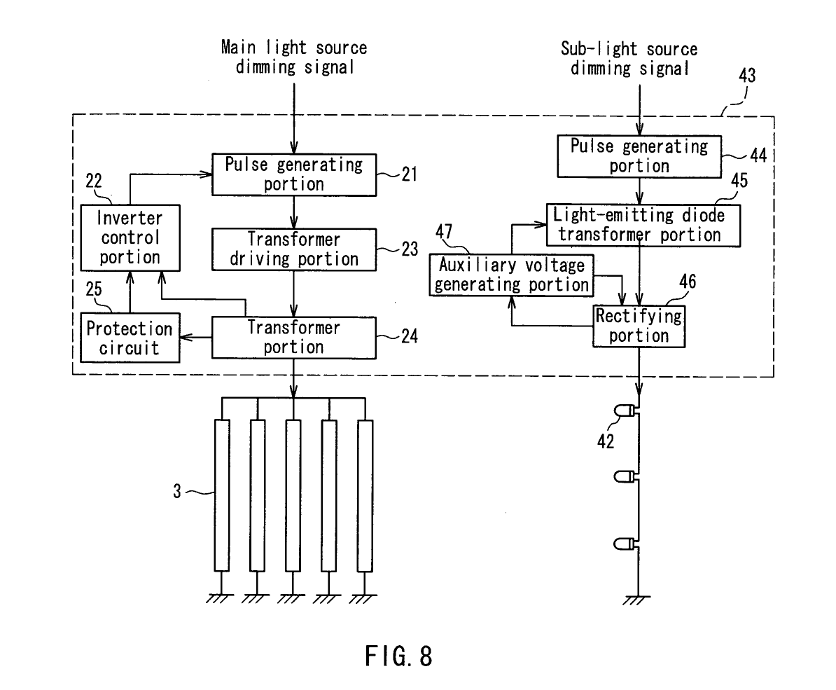

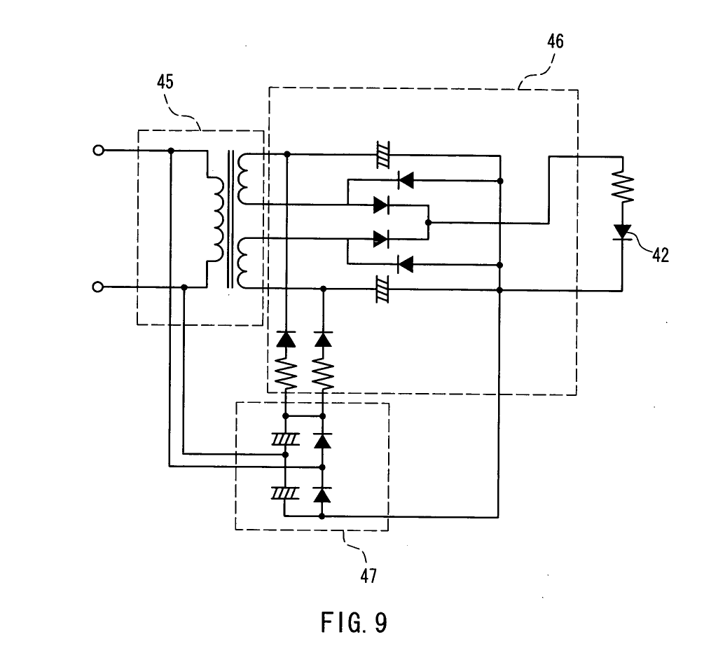

Next, a backlight device and a liquid crystal display device in Embodiment 2 of the present invention will be described with reference to FIGS. 7 to 9. FIG. 7 is a block diagram showing configurations of a backlight device and a liquid crystal display device according to Embodiment 2 of the present invention. FIG. 8 is a block diagram showing a specific configuration of a driving portion constituting the backlight device shown in FIG. 7. FIG. 9 is a circuit diagram exclusively showing a portion for driving the sub-light source in the driving portion shown in FIG. 7.

In the present Embodiment 2, a backlight device 41 includes a plurality of light-emitting diodes as a sub-light source 42, which differs from the backlight device 1 in Embodiment 1. Further, since the sub-light source 42 is formed of light-emitting diodes, a configuration of a driving portion 43 also differs from that of the driving portion 8 in Embodiment 1.

Except the aforementioned differences, the backlight device 41 and the liquid crystal display device in the present Embodiment 2 are configured in the same manner as the backlight device 1 and the liquid crystal display device in Embodiment 1. Hereinafter, the differences will be described specifically.

In the present Embodiment 2, as shown in FIG. 7, in place of the fluorescent tube constituting the sub-light source 5 shown in FIGS. 1 and 2, a plurality of light-emitting diodes constituting the sub-light source 42 are disposed along a side surface of the light guide plate 4 so as to allow the emitted light to be incident upon the surface side. The driving portion 43 drives the fluorescent tubes constituting the main light source 3, and the light-emitting diodes constituting the sub-light source 42.

As shown in FIG. 8, the driving portion 43, like the driving portion 8 in Embodiment 1, includes the pulse generating portion 21, the inverter control portion 22, the transformer driving portion 23, the transformer portion 24, and the protection circuit 25. The driving portion 43 drives the fluorescent tubes constituting the main light source 3 by the PWM dimming method, like in Embodiment 1.

Further, as shown in FIGS. 8 and 9, the driving portion 43 includes a pulse generating portion 44, a light-emitting diode transformer portion 45, a rectifying portion 46, and an auxiliary voltage generating portion 47, and these modulate a value of current that is supplied to the light-emitting diodes constituting the sub-light source 42. As a result, the light-emitting diodes emit light in an amount instructed by a sub-light source dimming signal.

Specifically, the sub-light source dimming signal from the control portion 15 is input to the pulse generating portion 44. The pulse generating portion 44 generates a pulse from the input sub-light source dimming signal, as the pulse generating portion 31 shown in FIG. 4 does.

The pulse generated in the pulse generating portion 44 is input to the light-emitting diode transformer portion 45. The light-emitting diode transformer portion 45 boosts the input pulse, and inputs it to the rectifying portion 46. The rectifying portion 46 rectifies the input pulse, and generates a direct current. Then, the generated direct current is supplied to the light-emitting diodes constituting the sub-light source 42, so as to lighten the light-emitting diodes. The auxiliary voltage generating portion 47 applies a voltage preliminarily to the light-emitting diode transformer portion 45 for suppressing the occurrence of a time-lag between an instruction of lighting of the sub-light source 42 and a start of the lighting.

The current value of the direct current generated by the rectifying portion 46 is proportional to the duty ratio of the pulse that is output by the pulse generating portion 44. Therefore, the light-emitting diodes have a brightness in accordance with the voltage level or the duty ratio of the sub-light source dimming signal. In the present Embodiment 2, the driving portion 43 drives the light-emitting diodes constituting the sub-light source 42 by the PWM dimming method in accordance with an instruction given by the control portion 15.

As described above, the backlight device of the present Embodiment 2, like the backlight device of Embodiment 1, is capable of increasing the maximum brightness and widening a dimming range compared to the conventional backlight device. Further, in the present Embodiment 2, an increase in current passing through the main light source 3 and the sub-light source 5 can be suppressed, whereby a decrease in the service life of light sources can be suppressed.

In Embodiments 1 and 2, although the adjustment of the light amounts of the main light source and the sub-light source is performed in accordance with the contents of a video image displayed on the display screen, the present invention is not limited to the foregoing examples. The present invention, for example, may be configured so that the sub-light source is switched on and off manually by a user of the liquid crystal display device.

### INDUSTRIAL APPLICABILITY

The backlight device and the liquid crystal display device according to the present invention have an industrial applicability as a backlight device configured so that a decrease in a service life of a light source is suppressed and as a liquid crystal display device having an improved contrast ratio, respectively.

1. A backlight device comprising:
an optical layer having one of main surfaces thereof as a light outgoing surface;
a main light source that is disposed at a position facing the other main surface of the optical layer and emits light toward the optical layer;
a light guide plate that is disposed on a side of the other main surface of the optical layer, so as to be parallel to the optical layer, and has a main surface on an optical layer side as a light outgoing surface;
a sub-light source that is disposed at a position facing a side surface of the light guide plate and emits light toward the side surface; and
a driving portion for driving the main light source and the sub-light source,
wherein the main light source includes a plurality of fluorescent tubes disposed parallel to the optical layer, and
the driving portion outputs drive pulses with respect to the plurality of the fluorescent tubes, respectively, and adjusts light amounts of the plurality of the fluorescent tubes by modulating pulse widths of the drive pulses.

2. The backlight device according to claim 1,
wherein the sub-light source is a fluorescent tube disposed along the side surface of the light guide plate, and
the driving portion further outputs a drive pulse with respect to the fluorescent tube constituting the sub-light source and adjusts a light amount of the fluorescent tube constituting the sub-light source by modulating a pulse width of the drive pulse.

3. The backlight device according to claim 1,
wherein the sub-light source is a light-emitting diode disposed along the side surface of the light guide plate, and
the driving portion adjusts a light amount of the light-emitting diode constituting the sub-light source by modulating a value of current supplied to the light-emitting diode constituting the sub-light source.

4. The backlight device according to claim 1, wherein the main light source is disposed between the optical layer and the light guide plate.

5. A liquid crystal display device comprising:
a liquid crystal display panel; and
a backlight device for illuminating the liquid crystal display panel from a back surface thereof,
wherein the backlight device includes:
an optical layer having one of main surfaces thereof as a light outgoing surface;
a main light source that is disposed at a position facing the other main surface of the optical layer and emits light toward the optical layer;
a light guide plate that is disposed on a side of the other main surface of the optical layer, so as to be parallel to the optical layer, and has a main surface on an optical layer side as a light outgoing surface;
a sub-light source that is disposed at a position facing a side surface of the light guide plate and emits light toward the side surface; and
a driving portion for driving the main light source and the sub-light source,
wherein the main light source includes a plurality of fluorescent tubes disposed parallel to the optical layer, and
the driving portion outputs drive pulses with respect to the plurality of the fluorescent tubes, respectively, and adjusts light amounts of the plurality of the fluorescent tubes by modulating pulse widths of the drive pulses.

6. The liquid crystal display device according to claim 5,
wherein the sub-light source is a fluorescent tube disposed along the side surface of the light guide plate, and
the driving portion further outputs a drive pulse with respect to the fluorescent tube constituting the sub-light source and adjusts a light amount of the fluorescent tube constituting the sub-light source by modulating a pulse width of the drive pulse.

7. The liquid crystal display device according to claim 5,
wherein the sub-light source is a light-emitting diode disposed along the side surface of the light guide plate, and
the driving portion adjusts a light amount of the light-emitting diode constituting the sub-light source by modulating a value of current supplied to the light-emitting diode constituting the sub-light source.

8. The liquid crystal display device according to claim 5, wherein the main light source is disposed between the optical layer and the light guide plate.

9. The liquid crystal display device according to claim 6, further comprising a control portion that causes the driving portion to adjust the light amounts of the main light source and the sub-light source in accordance with a configuration of an image displayed on a display screen of the liquid crystal display panel.

10. The liquid crystal display device according to claim 7, further comprising a control portion that causes the driving portion to adjust the light amounts of the main light source and the sub-light source in accordance with a configuration of an image displayed on a display screen of the liquid crystal display panel.
